(19) United States
(12) Patent Application Publication
(10) Pub. No.: US 2019/0193634 A1
(43) Pub. Date: Jun. 27, 2019

(54) VEHICLE

(71) Applicant: Toyota Jidosha Kabushiki Kaisha, Toyota-shi Aichi-ken (JP)

(72) Inventors: Megumi Amano, Toyota-shi Aichi-ken (JP); Kohei Maejima, Nagakute-shi Aichi-ken (JP); Chika Kajikawa, Toyota-shi Aichi-ken (JP); Hikaru Gotoh, Nagoya-shi Aichi-ken (JP); Yoshiaki Matsumura, Toyota-shi Aichi-ken (JP); Chiharu Hayashi, Nagoya-shi Aichi-ken (JP)

(21) Appl. No.: 16/225,591

(22) Filed: Dec. 19, 2018

(30) Foreign Application Priority Data
Dec. 27, 2017 (JP) 2017-252266

(51) Int. Cl. B60R 1/00; G06K 9/00; B60W 40/06

(52) U.S. Cl. CPC B60R 1/00; B60R 2300/804; B60W 40/06; G06K 9/00798

(57) ABSTRACT

Provided is a vehicle including (i) a vehicle main body, (ii) a road width information acquisition unit that acquires road width information relating to a width of a road surrounding the vehicle main body, and (iii) a display unit that displays width positions of the road based on the road width information acquired by the road width information acquisition unit, the display unit being arranged in a compartment of the vehicle main body.

### CROSS-REFERENCE TO RELATED APPLICATION

This application claims priority under 35 USC 119 from Japanese Patent Application No. 2017-252266 filed on Dec. 27, 2017, the disclosure of which is incorporated by reference herein in its entirety.

### BACKGROUND

### Technical Field

The present disclosure relates to a vehicle.

### Related Art

Japanese Patent Application Laid-Open (JP-A) No. 2016-147528 discloses an image display device including: a center display which is a transparent type display; and a left display and a right display, which are positionally switched between a first position behind the center display and a second position different from the first position. At the first position, the left display and the right display each display a second image associated with a first image displayed on the center display.

In the actual operations of a vehicle, for example, depending on the weather and the like, there are cases where it is difficult to drive the vehicle due to the difficulty in visually recognizing the width positions of the road. The technology of JP-A No. 2016-147528 is not configured in such a manner to facilitate visual recognition of the width positions of a road; therefore, there is room for improvement in terms of making driving easier.

### SUMMARY

The present disclosure makes driving easier in a case in which it is difficult to visually recognize the width positions of a road.

In a first aspect of the present disclosure, a vehicle includes (i) a vehicle main body, (ii) a road width information acquisition unit that acquires road width information relating to the width of a road surrounding the vehicle main body, and (iii) a display unit that displays width positions of the road based on the road width information acquired by the road width information acquisition unit, the display unit being arranged in the compartment of the vehicle main body.

In the vehicle according to the first aspect, the road width information acquisition unit acquires road width information relating to a width of the road surrounding the vehicle main body. Based on this road width information, the display unit displays the width positions of the road. The occupant can obtain a knowledge of the width positions of the road by visually recognizing the width positions of the road displayed by the display unit. Even when it is difficult to visually recognize the width positions of the road, the occupant may easily drive the vehicle by knowing the width positions of the road.

In a second aspect, the display unit according to the first aspect includes a projection member which projects an image on a window of the vehicle main body.

In the second aspect, since an image indicating the width positions of the road is projected and displayed on the window by the projection member, it is easy to visually recognize the width positions of the road.

In a third aspect, the projection member according to the second aspect projects the width positions on the window with lines.

In the third aspect, since the width positions of the road are displayed with lines, the width positions (boundaries) of the road can be clearly indicated.

In a fourth aspect, the vehicle according to any one of the first to the third aspects includes a visibility condition sensor which detects a visibility condition of the width of the road surrounding the vehicle main body, and the display unit displays the width positions in accordance with the visibility condition detected by the visibility condition sensor.

In the fourth aspect, the display unit displays the width positions of the road in accordance with the visibility condition of the width of the road surrounding the vehicle main body that is detected by the visibility condition sensor. For example, even when the width positions of the road are not visually recognizable, the width positions of the road can be appropriately displayed.

In a fifth aspect, the vehicle according to any one of the first to the fourth aspects includes an input unit which receives an input of a display request for the width positions from an occupant, and the display Unit displays the width positions in the presence of the input of the display request.

In the fifth aspect, the display unit displays the width positions of the road in the presence of an input of a display request; however, the display unit does not display the width positions in the absence of such an input and is thereby prevented from having excessive display contents. For example, when the display unit does not display the width positions, it can display other information, in place of the width positions.

In a sixth aspect, in the vehicle according to any one of the first to the fifth aspects, the road width information acquisition unit includes a vehicle location information acquisition unit that detects location information of the vehicle, and the display unit acquires the width positions from an external database and displays the width positions based on the vehicle location acquired by the vehicle location information acquisition unit.

The display unit acquires the width positions of the road from an external database and displays the width positions; therefore, for example, even when the width positions of the road are not recognizable by image capturing or the like, the width positions of the road can be displayed.

The road width information acquisition unit includes the vehicle location information acquisition unit and is thus capable of acquiring the width positions of the road from an external database in accordance with the location of the vehicle.

In a seventh aspect, in the vehicle according to any one of the first to the sixth aspects, the road width information acquisition unit includes an imaging camera which captures an image of the surroundings of the vehicle and thereby acquires the width positions.

In the seventh aspect, since an image of the road is captured by the imaging camera, the width positions can be displayed more accurately.

In an eighth aspect, the display unit according to the seventh aspect corrects the width positions of the road based on the image captured by the imaging camera and displays the thus corrected width positions.

In the eighth aspect, since the display unit corrects and then displays the width positions of the road, the width positions can be displayed more accurately.

The ninth aspect of the present disclosure is a method for displaying road width position, the method comprising (i) acquiring road width information relating to a width of a road surrounding a vehicle main body, and (ii) displaying width positions of the road based on the acquired road width information, at a display unit disposed in a compartment of the vehicle main body.

The tenth aspect of the present disclosure is a non-transitory computer readable medium storing a program that causes a computer to execute a process for displaying road width position, the process comprising (i) acquiring road width information relating to a width of a road surrounding a vehicle main body, and (ii) displaying width positions of the road based on the acquired road width information, at a display unit disposed in a compartment of the vehicle main body.

According to the present disclosure, driving can be made easier even when it is difficult to visually recognize the width positions of a road.

### BRIEF DESCRIPTION OF THE DRAWINGS

Exemplary embodiments of the present disclosure will be described in detail based on the following figures, wherein:

FIG. 1 is a side view illustrating a vehicle of a first embodiment;

FIG. 2 is a view taken from the inside of the compartment toward the front in the vehicle of the first embodiment;

FIG. 3 is a drawing that illustrates the position of the windshield in the vehicle of the first embodiment;

FIG. 4 is a block diagram of the vehicle of the first embodiment;

FIG. 5 is a drawing that illustrates the state of division lines viewed from the windshield toward the front in the vehicle of the first embodiment;

FIG. 6 is a flow chart of a road width position information display process in the vehicle of the first embodiment;

FIG. 7 is a drawing that illustrates one example of an image displayed on a display panel in the vehicle of the first embodiment;

FIG. 8 is a drawing that illustrates one example of an image projected from the projection member in the vehicle of the first embodiment;

FIG. 9 is a drawing that illustrates the width between projected division lines and that between actual lines;

FIG. 10 is a drawing that illustrates one example of an image projected from the projection member in the vehicle of the first embodiment, the example being different from the one illustrated in FIG. 8; and

FIG. 11 is a block diagram illustrating a hardware configuration of a control unit of a control device.

### DETAILED DESCRIPTION

A vehicle 102 according to the first embodiment of the present disclosure will now be described in detail referring to the figures. The simple terms “front side” and “rear side” used herein mean the front side and the rear side along the vehicle anteroposterior direction, respectively, and the terms “upper side” and “lower side” mean the upper side and the lower side along the vehicle vertical direction, respectively.

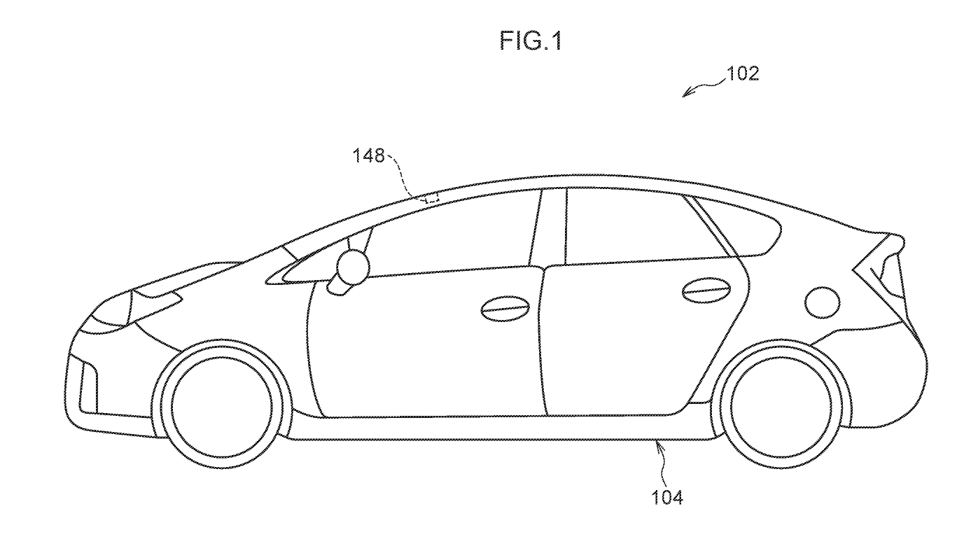

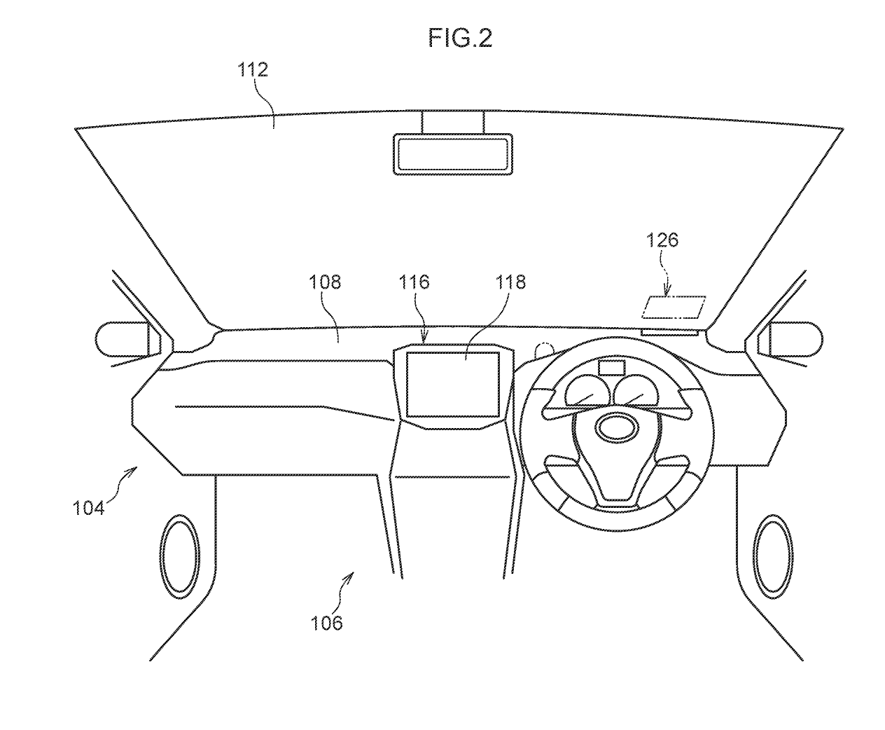

As illustrated in FIGS. 1 and 2, the vehicle 102 includes a vehicle main body 104, inside of which is a vehicle compartment 106. A dashboard 108 is arranged on the front side of the vehicle compartment 106, and a windshield 112 is arranged above the dashboard 108.

A display panel 116 is arranged on the dashboard 108. In this embodiment, the display panel 116 is arranged at a central position in the vehicle widthwise direction on the dashboard 108.

The display panel 116 doubles as an input device 118 and also functions as an input panel which receives an input made by an occupant's touch operation. As the input device 118, an input display (e.g., a touch panel) or various input switches (e.g., push buttons and slide switches) may be arranged separately from the display panel 116. Further, for example, a microphone which receives a voice input from an occupant, or a sensor which detects a motion of an occupant (movement of an arm or a fingertip) can also be used as the input device 118. For example, by inputting the place where the vehicle main body 104 is heading to (occupant's destination) using the input device 118 to display information on a route to the destination on the display panel 116, the display panel 116 is allowed to function as a part of a car navigation system. The information on the route to the destination may be presented by a device other than the display panel 116, for example, by voice from a speaker (not illustrated).

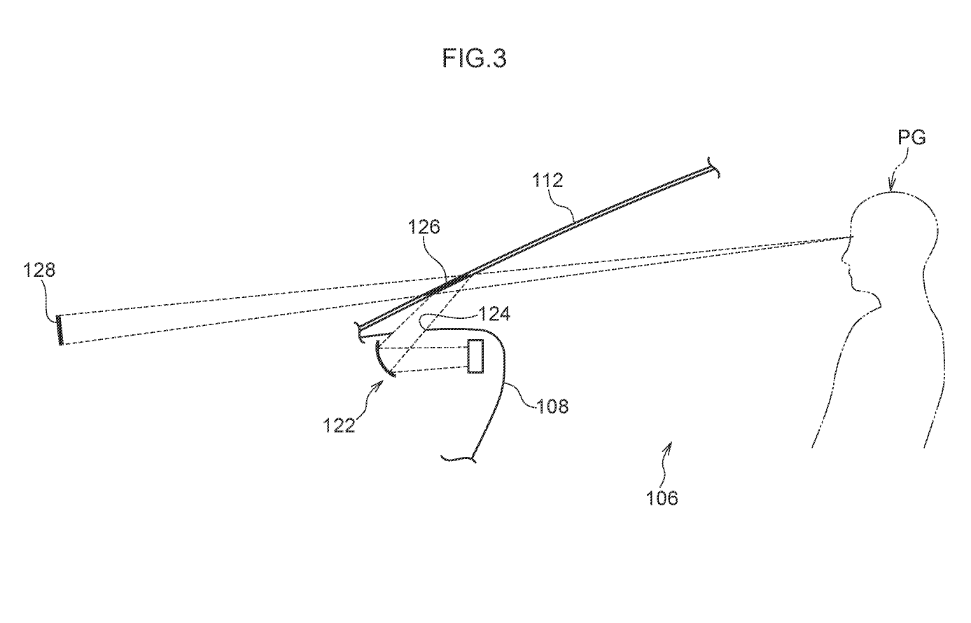

As illustrated in FIG. 3, a projection member 122 is arranged inside the dashboard 108. The projection member 122 is one example of the display unit of the present disclosure.

The projection member 122 projects a projected image 126 at a prescribed position on the windshield 112 through a projection window 124 of the dashboard 108. This projected image 126 is projected in such a manner to form a virtual image 128 further on the front side than the windshield 112 when viewed from an occupant PG. The occupant PG can visually recognize the projected image 126 in a superimposed manner with the sight outside the vehicle created by the light transmitting through the windshield 112. In other words, the projection member 122 of this embodiment is a head-up display.

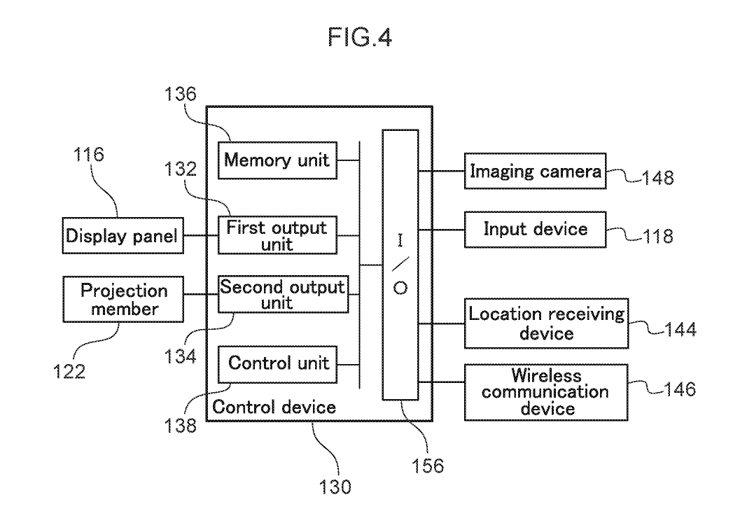

As illustrated in FIG. 4, a control device 130 is connected to the display panel 116 and the projection member 122. The control device 130 includes a first output unit 132 and a second output unit 134. The first output unit 132 and the second output unit 134 each output a prescribed image to the display panel 116 and the projection member 122, respectively.

The control device 130 also includes a memory unit 136 and a control unit 138. In the memory unit 136, for example, a road width position display program for executing the below-described “road width position display process” has been stored in advance. Further, the input device 118 is connected to the control device 130, and it is configured such that information inputted to the input device 118 is transmitted to the control device 130.

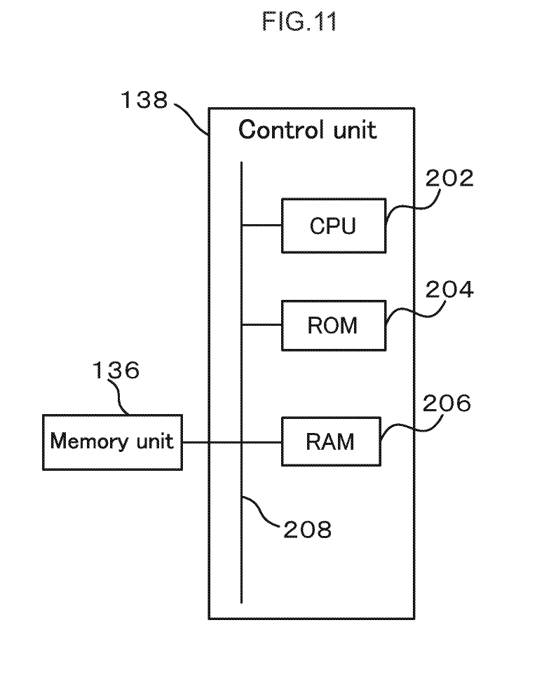

FIG. 11 shows a block diagram of a hardware configuration of the control unit 138. The control unit 138 includes a Central Processing Unit (CPU) 202, a Read Only Memory (ROM) 204, and a Random Access Memory (RAM) 206. The control unit 138 is connected to the memory unit 136. These components are connected in a mutual communication manner via a bus 208.

The CPU 202 is formed as a central processing unit so as to execute various programs and to control each portion. That is, the CPU 202 reads a program from the ROM 204 or the memory unit 136 and executes the program using the RAM 206 as a working area. The CPU 202 performs the control of each unit included in the vehicle main body 104 and various calculations in accordance with the program stored in the ROM 204 or the memory unit 136.

The ROM 204 stores various programs and various data. Note that programs and data, or portions thereof, which are described to be stored in the memory unit 136 throughout the present disclosure, can be stored at the ROM 204 instead of the memory unit 136. The RAM 206 stores the programs or the data temporarily as a working area.

For convenience of explanation, hereinafter, performing various functions of the vehicle main body 104 by the ROM 204 of the control unit 138 executing the road width position information display program stored in the memory unit 136 is described as that the control unit 138 controls the vehicle main body 104.

To an I/O (Input/Output) port 156 of the control device 130, in addition to the input device 118, a location receiving device 144, an imaging camera 148 and a wireless communication device 146 are also connected. The control unit 138, in accordance with the various information inputted to the control device 130, processes image information to be outputted from each of the first output unit 132 and the second output unit 134 to the display panel 116 and the projection member 122.

The location receiving device 144 receives current location information of the vehicle 102 from, for example, a global positioning system (GPS). The location receiving device 144, which is one example of the location information acquisition unit of the present disclosure, is controlled by the control unit 138 of the control device 130. The wireless communication device 146, for example, wirelessly communicates with an external server via an inter-net connection or the like to transmit and receive information. The wireless communication device 146 of this embodiment is capable of acquiring information on the road width positions based on the current location of the vehicle 102.

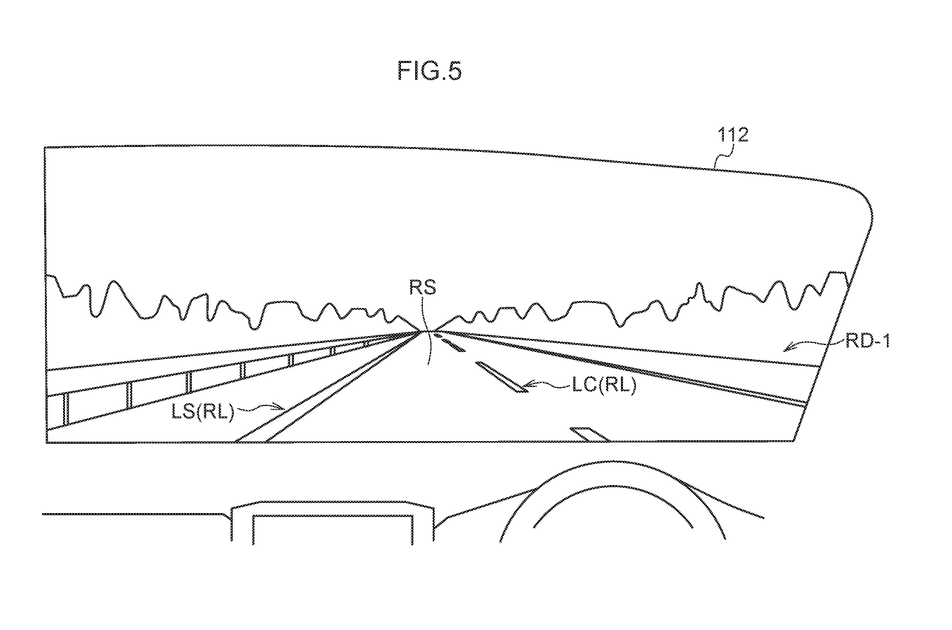

For a road having division lines, the term “width positions” refers to the boundary positions of the division lines on each widthwise side of the lane on which the vehicle 102 is travelling. For example, as illustrated in FIG. 5, on a two-lane road RD-1, the positions of a roadway center line LC and a roadway edge line LS each correspond to the “width positions”.

Meanwhile, the “width positions” on a road having no division line can be set as the positions of the boundaries along the road widthwise direction between the area where the vehicle can substantially travel and the areas where the vehicle cannot travel. For example, in the case of a road having a shoulder, a curbstone, a gutter, a sidewalk, a slope and/or the like on each side, such shoulder, curbstone, gutter, sidewalk, slope and the like are the areas where the vehicle cannot travel.

As illustrated in FIG. 1, the imaging camera 148 is attached to the vehicle main body 104 in such a manner that it can take images ahead of the vehicle. In this embodiment, as one example of an imaging device, a camera which is capable of capturing images of a prescribed area wider than the road width (lane width in the case of a multi-lane road) as still pictures at prescribed time intervals or as a video is used. The imaging camera 148 transmits the thus obtained information of the captured images ahead of the vehicle main body 104 to the control device 130. The wireless communication device 146 and the imaging camera 148 are examples of the road width information acquisition unit of the present disclosure. The control unit 138 of the control device 130 reads out a prescribed program stored in the memory unit 136 and executes the control of the road width information acquisition unit.

The imaging device is not restricted to a camera that takes images of visible light and may be, for example, a camera that takes images using infrared or ultraviolet radiation. These cameras are also examples of the imaging device and, at the same time, examples of the visibility condition sensor of the present disclosure. The control unit 138 of the control device 130 reads out a prescribed program stored in the memory unit 136 and executes the control of the visibility condition sensor.

The term “visibility condition” refers to a state whether or not the occupant PG can visually recognize the width positions of a road surrounding the vehicle main body 104. Accordingly, examples of the visibility condition sensor include those sensors that are configured to detect the shape of a road surface RS and acquire information on the road width positions by irradiating ultrasonic waves to the road surface RS or by irradiating a laser to the road surface RS using a laser interferometer. Any of such visibility condition sensors can be used to determine the visibility condition of the width positions (actual division lines RL) of the road surrounding the vehicle main body 104, i.e., information used for judging whether or not the occupant PG can visually recognize the width positions of the road.

Even when the occupant PG cannot visually recognize the width positions of the road, there are cases where the width positions of the road can be recognized as a captured image by adjusting the light exposure or taking an image through an appropriate filter in the image capturing performed by the imaging camera 148. Similarly, in some cases, the width positions of the road can be recognized as a captured image by adopting a configuration that takes an image using infrared or ultraviolet radiation or a configuration that detects the shape of the road surface using a laser interferometer.

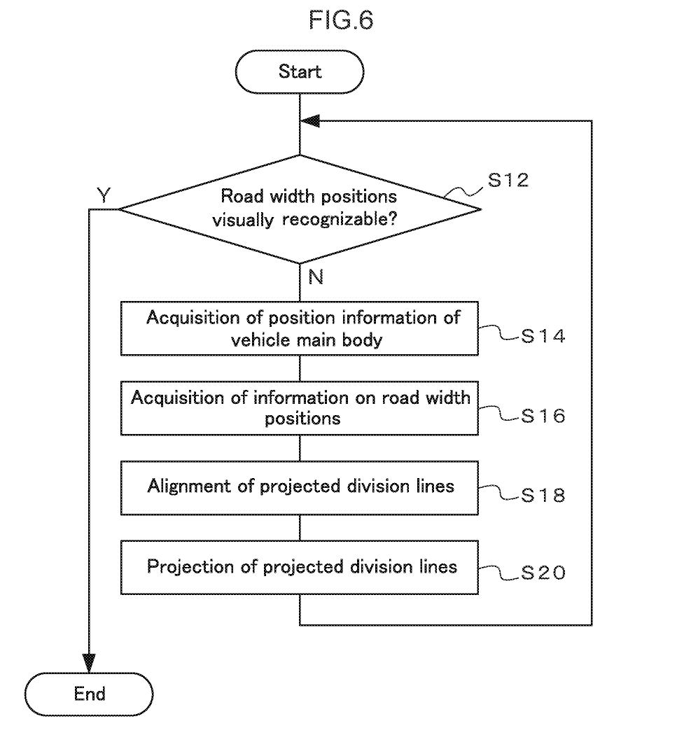

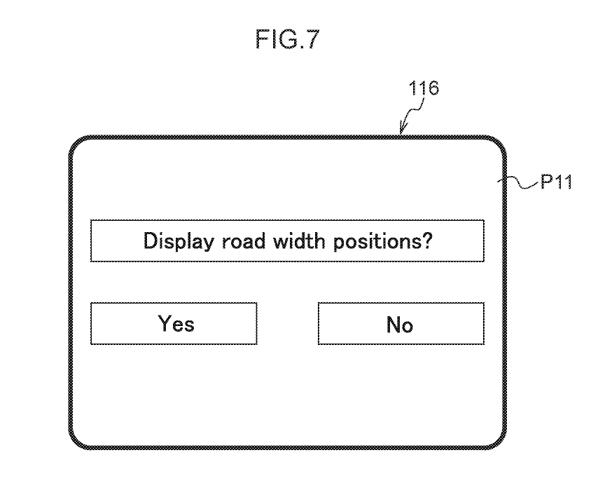

Next, a method of displaying the “width positions” of a road ahead of the vehicle 102 of this embodiment will be described. In the vehicle 102 of this embodiment, the control unit 138 of the control device 130 reads out a prescribed program stored in the memory unit 136 and executes a “road width position display process” for displaying a prescribed display content using the display panel 116 and the projection member 122 in accordance with the flow illustrated in FIG. 6. In the execution of this “road width position display process”, as illustrated in FIG. 7, the control device 130 displays, on the display panel 116, a selection screen P11 which asks whether or not to display the “width positions” of the road. Then, when it is judged that an input for not displaying the “width positions” of the road has been made, the “road width position display process” is not executed. In other words, the “road width position display process” is executed when it is judged that an input for displaying the width positions of the road has been made.

First, in the step S12, the control device 130 judges the visibility condition ahead of the vehicle 102, i.e., whether or not the occupant PG can visually recognize the width positions of the road. Specifically, based on an image ahead of the vehicle that is taken by the imaging camera 148 (hereinafter, this image is referred to as “captured image”), it is judged whether or not the division lines of the road (e.g., white solid lines, white dotted lines and yellow solid lines, which are hereinafter referred to as “actual division lines RL”; see FIG. 5) can be distinguished from the road surface RS excluding the actual division lines RL. For example, in the case of snowfall on the road surface, the actual division lines RL are sometimes not visually recognizable. Further, when rainwater remains on the road surface RS or in the event of dense fog, heavy rain or the like, it may be difficult to visually recognize the actual division lines RL. Whether or not the actual division lines RL are actually visually recognizable can be determined by comparing the hue and the brightness between the actual division lines RL and the road surface RS excluding the actual division lines RL.

In the step S12, if the width positions are judged to be visually recognizable, the control device 130 terminates the “road width position display process”.

On the other hand, when the width positions are judged to be not visually recognizable in the step S12, the process proceeds to the step S14. In the step S14, the control device 130 acquires location information of the vehicle main body 104 from the location receiving device 144. Further, in the step S16, the control device 130 acquires information on the width positions of the road. Specifically, for example, the control device 130 accesses an external server via the wireless communication device 146 and acquires the information on the “width positions” from an image of the road at the current location of the vehicle main body 104 (this image is hereinafter referred to as “acquired image”). When the road has actual division lines RL in an aerial photograph of the road that is stored in the external server, the information on the “width positions” can be acquired as the positions of the actual division lines RL. Meanwhile, when the road has no actual division line Rh or the road has actual division lines RL but they are unclear on the aerial photograph, for example, the information on the “width positions” can be estimated from the positions of a curbstone, a guardrail, a shoulder, a sidewalk, a slope and the like of the road. Further, the information on the “width positions” of the road may be recorded in advance in the memory unit 136 of the control device 130 while the “width positions” of the road are recognizable, and this information may be extracted. In the following, a case where the information on the “width positions” of the actual division lines RL has been obtained from the “acquired image” is described as an example.

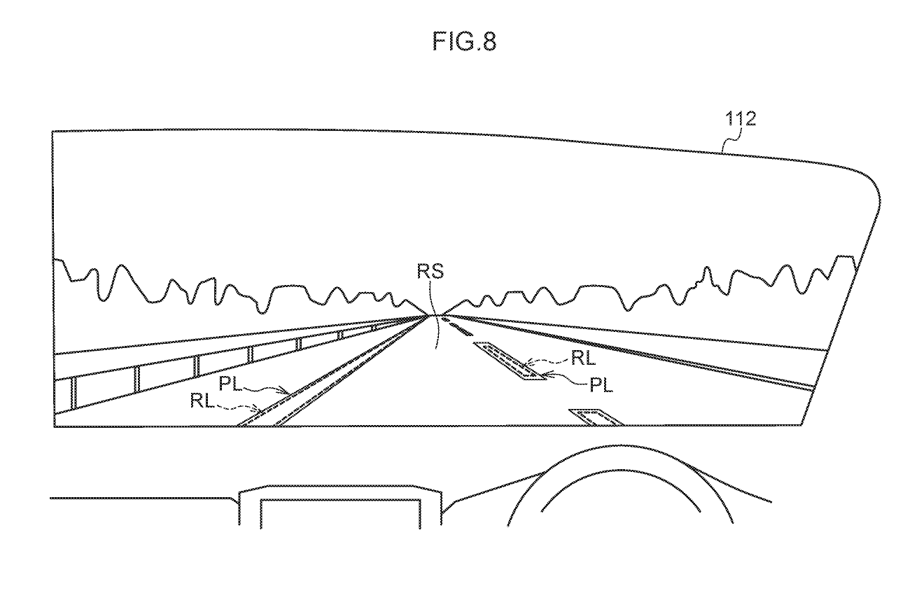

Subsequently, the control device 130 proceeds to the step S18. In the step S18, the control device 130 executes “alignment” in which the positions of division lines projected from the projection member 122 (hereinafter, these division lines are referred to as “projected division lines PL”; see FIG. 8) are corrected such that they are aligned with the actual position of the road. In other words, the captured image obtained by the imaging camera 148 and the acquired image obtained from the location receiving device 144 are compared, and the positions at which the projected division lines PL should be projected are determined based on the captured image. The positions of the projected division lines PL are corrected based on the captured image; therefore, displacement of the projected division lines PL.

The control device 130 then proceeds to the step S20. In the step S20, the control device 130 projects the projected division lines PL at the thus determined respective positions from the projection member 122. As illustrated in FIG. 8, the projected division lines PL are projected on the windshield 112, allowing the occupant PG to visually recognize the projected division lines PL. In other words, even in a situation where the occupant PG cannot visually recognize the actual division lines RL or has difficulty in visually recognizing the actual division lines RL, the occupant PG can easily visually recognize the projected division lines PL to drive the vehicle 102.

Thereafter, the process returns back to the step S12. In the step S12, the control device 130 again judges the visibility condition ahead of the vehicle 102, i.e., whether or not the occupant PG can visually recognize the width positions of the road.

It is noted here that the projected division hues PL indicating the width positions of the road can also be displayed on the display panel 116. For example, the captured image of the road that is taken by the imaging camera 148 may be displayed on the display panel 116, and the width positions of the road (projected division lines PL) may be superimposed on the captured image on the display panel 116. In contrast, in the above-described embodiment, since the width positions of the road (projected division lines PL) are projected and displayed on the windshield 112, the width positions of the road are displayed over the actual road; therefore, it is easy to visually recognize the width positions of the road.

In this manner, the window on which the width positions of the road are displayed is not restricted to the windshield 112. For example, a projection member which projects images on a rear window or a door glass may be arranged inside the vehicle compartment 106 so as to display the width positions of the road on the rear window or the door glass.

Particularly, in the above-described embodiment, since the positions of the projected division lines PL are corrected based on the captured image, displacement of the projected division lines PL is inhibited, so that the projected division lines PL can be displayed at more accurate positions (positions closer to those of the actual division lines RL).

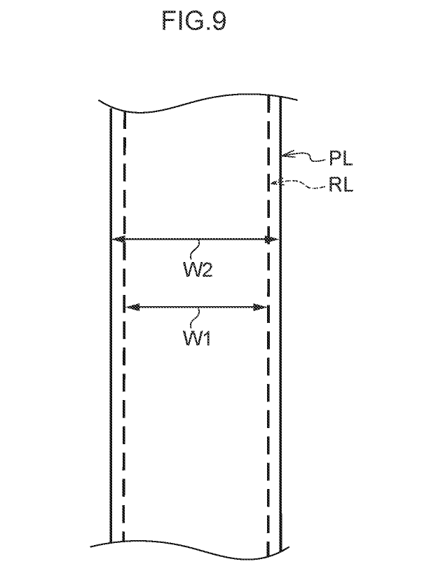

In this embodiment, as illustrated in FIG. 9, in the projected division lines PL, a width W2 visually recognized by the occupant PG from the inside of the vehicle compartment 106 is set to be wider than a width W1 between the actual division lines RL (a width that is also visually recognized by the occupant PG from the inside of the vehicle compartment 106). Thus, even if the positions of the projected division lines PL are slightly displaced in the widthwise direction with respect to the positions of the actual division lines RL, a state where the projected division lines PL exist within an area containing actual division lines RL can be realized.

Moreover, in the above-described embodiment, an image of the surroundings of the vehicle 102 is captured by the imaging camera 148, and the positions at which the projected division lines PL should be projected are determined using the thus captured image. As compared to a configuration in which no image of the surroundings of the vehicle 102 is taken by the imaging camera 148, the positions of the projected division lines PL can be determined more accurately.

In addition, since an image of the outside of the vehicle 102 is captured by the imaging camera 148, it is possible to judge whether or not the occupant can visually recognize the width positions of the road and to perform a process of displaying the projected division lines PL when the occupant cannot visually recognize the width positions of the road. When the actual division lines RL are visually recognizable, the power consumption of the projection member 122 can be reduced by not displaying the projected division lines PL.

Furthermore, in the above-described embodiment, since the input device 118 is provided, the occupant can select whether or not to display the width positions of the road. When the occupant does not wish to display the width positions of the road, the power consumption of the projection member 122 can be reduced by not displaying the width positions of the road. In addition, by not displaying the width positions of the road, it is possible to prevent the contents to be displayed on the windshield 112 from being excessive and thus, for example, other information can also be displayed in place of the width positions of the road.

In the above-described embodiment, the width positions of the road can be recognized based on an image captured by the imaging camera 148; however, depending on the situation, it may be difficult to recognize the width positions of the road. Still, even when the width positions of the road cannot be recognized based on an image captured by the imaging camera 148, since the information on the width positions of the road is acquired from an external database, the width positions of the road can be displayed by projecting the division lines PL using the projection member 122.

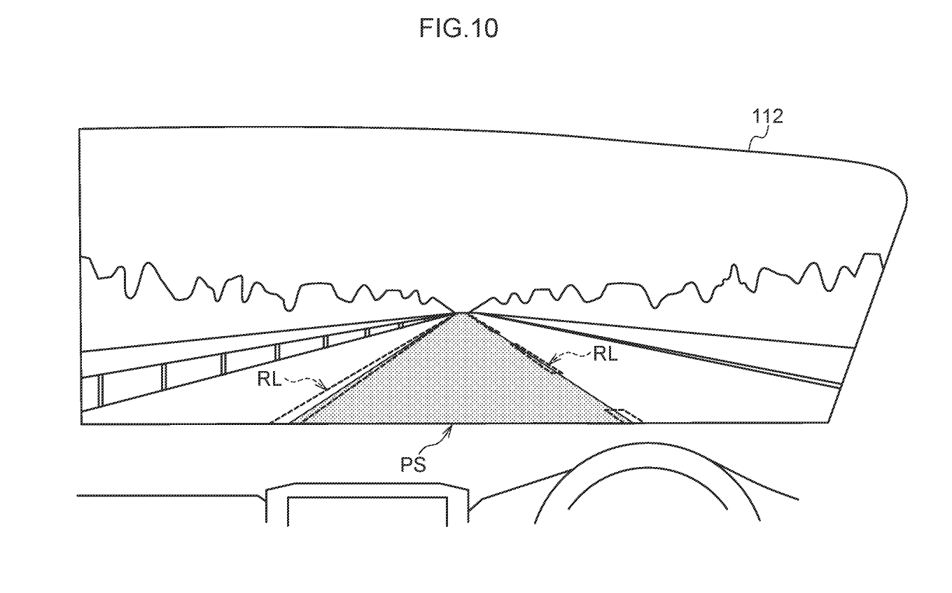

It is noted here that, although a case of displaying the width positions of a road with projected division lines PL was described above as one example, the display of the width positions of a road is not restricted to such a case of using lines. For example, as illustrated in FIG. 10, the entirety of a road lane on which the vehicle 102 can travel may be displayed as a projected surface PS, Further, a virtual guardrail may be displayed at a width position of the road surface RS. By displaying the width positions of a road with projected division lines PL, i.e., lines, the width positions of the road are made clear and thus easily visually recognized.

Further, the road width position display process performed by the CPU 202 reading the program in the embodiment described above may be performed various processors other than a CPU. In this case, an example of the processor includes a Programmable Logic Device (PLD), the circuit configuration of which can be changed after manufacturing the device, such as a Field-Programmable Gate Array (FPGA), and a specific electric circuit formed as a processor having a circuit configuration specifically designed for performing specific processing such as an Application Specific Integrated Circuit (ASIC). Further, the location-related information display processing may be performed by one of the various processors, or a combination of two or more of similar processors or different processors (for example, a combination of a plurality of the FPGAs, a combination of the CPU and the FPGA, or the like). Further, a hardware configuration of the various processors is specifically formed as an electric circuit combining circuit elements such as semiconductor element.

Further, in the embodiments described above, the location-related information display program is stored in the memory unit 136 or the ROM 204, however it is not limited to this. The program may be provided by a storage medium such as a Compact Disk Read Only Memory (CD-ROM), a Digital Versatile Disk Read Only Memory (DVD-ROM), and a Universal Serial Bus (USB) memory in which the program is stored, Further, the program may be downloaded from an external device through a network.

What is claimed is:

1. A vehicle comprising:
a vehicle main body;
a road width information acquisition unit that acquires road width information relating to a width of a road surrounding the vehicle main body; and
a display unit that displays width positions of the road based on the acquired road width information, the display unit being disposed in a compartment of the vehicle main body.

2. The vehicle according to claim 1, wherein the display unit comprises a projection member which projects an image on a window of the vehicle main body.

3. The vehicle according to claim 2, wherein the projection member projects the width positions on the window with lines.

4. The vehicle according to claim 1, wherein
the vehicle comprises a visibility condition sensor which detects a visibility condition of the width of the road surrounding the vehicle main body, and
the display unit displays the width positions in accordance with the detected visibility condition.

5. The vehicle according to claim 1, wherein
the vehicle comprises an input unit which receives an input of a display request for the width positions from an occupant, and
the display unit displays the width positions after the input of the display request.

6. The vehicle according to claim 1, wherein
the road width information acquisition unit comprises a vehicle location information acquisition unit that detects location information of the vehicle, and
the display unit acquires the width positions from an external database and displays the width positions used on the vehicle location acquired by the vehicle location information acquisition unit.

7. The vehicle according to claim 1, wherein the road width information acquisition unit comprises an imaging camera which captures an image of the surroundings of the vehicle and thereby acquires the width positions.

8. The vehicle according to claim 7, wherein the display unit corrects the width positions of the road based on the image captured by the imaging camera and displays the thus corrected width positions.

9. A method for displaying road width position, the method comprising:
acquiring road width information relating to a width of a road surrounding a vehicle main body; and
displaying width positions of the road based on the acquired road width information, at a display unit disposed in a compartment of the vehicle main body.

10. A non-transitory computer readable medium storing a program that causes a computer to execute a process for displaying road width position, the process comprising:
acquiring road width information relating to a width of a road surrounding a vehicle main body; and
displaying width positions of the road based on the acquired road width information, at a display unit disposed in a compartment of the vehicle main body.
